(19) United States
(12) Patent Application Publication
(10) Pub. No.: US 2003/0211867 A1
(43) Pub. Date: Nov. 13, 2003

(54) Telecommunication terminal for generating a sound signal from a sound recorded by the user

(75) Inventors: Pierre Bonnard, Suresnes (FR); Ivan Bourmeyster, Paris (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/429,857

(22) Filed: May 6, 2003

(30) Foreign Application Priority Data
May 7, 2002 (FR) 02 05 723

(51) Int. Cl. H04M 1/00

(52) U.S. Cl. 455/567; 455/550.1

(57) ABSTRACT

The present invention relates to a telecommunication terminal for generating a customized melody from an analog audio signal recorded by the user, more particularly one suitable for mobile telephony. The terminal comprises input means for receiving an analog audio signal, that includes at least one note, means for sampling and converting said analog audio signal into a digital signal and means for extracting from said digital signal at least three parameters representative of said analog audio signal, these being the frequency, the start time and the duration of said note. According to the invention, it includes means for modifying at least one of the three parameters so as to correct the sound imperfections associated with the quality or with the processing of said analog audio signal.

### CROSS-REFERENCE TO RELATED APPLICATIONS

This application is based on French Patent Application No. 02 05 723 filed May 7, 2002, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to a telecommunication terminal for generating a customized melody from an analog audio signal recorded by the user, more particularly one suitable for mobile telephony.

More and more mobile telephone users are using the same prerecorded ring tone indicating a call. Thus, when an apparatus rings, it is very difficult to differentiate the mobile telephones by their ring tones and the user may think he has received a call whereas it is a call being received on a nearby telephone. This type of problem is all the more critical when the user responds, although he is occupied with another activity, and when the call is not intended for him.

Likewise, the user of a personal digital assistant may wish to use different alerting tones depending on the applications.

2. Description of the Prior Art

Patent document WO 99/65221 discloses a solution to this problem.

To accomplish this, the telecommunication device disclosed in that document includes a microphone into which the user can whistle a melody. This whistled signal is an analog audio signal that is sampled and digitized via an analog/digital converter. The device also includes means for analyzing this signal and extracting therefrom parameters representative of notes characterized by a frequency and a duration. The extraction methods used combine the detection of the signal level allowing the duration of the notes to be defined and frequency detection methods, such as the FFT (Fast Fourier Transform) method, a “zero crossing”-type process or a process based on the mean of the absolute difference value of the AMDF (Absolute Mean Difference Function) type. Signal level detection is similar to VAD (Voice Activity Detection) employed in the coding of speech. The parameters are then stored in a memory and can be used to generate, for example, a customized telephone ring tone.

However, its implementation poses certain difficulties.

This is because the stored sound is not necessarily of high quality. This problem may stem from the insufficient quality of the microphone, from inaccuracy in the extraction method or simply from a sound poorly whistled by the user.

### SUMMARY OF THE INVENTION

The present invention aims to provide a telecommunication terminal for generating a high-quality customized melody from an analog audio signal recorded by a user.

For this purpose, the present invention provides a telecommunication terminal for generating a customized melody comprising input means for receiving an analog audio signal, that includes at least one note, means for sampling and converting said analog audio signal into a digital signal and means for extracting from said digital signal at least three parameters representative of said analog audio signal, these being the frequency, the start time and the duration of said note, which terminal includes means for modifying at least one of the three parameters so as to correct the sound imperfections associated with the quality or with the processing of said analog audio signal.

Advantageously, the terminal includes tempo detection means.

According to one particularly advantageous embodiment, the telecommunication terminal includes means for correcting the start times and the duration of the notes associated with said received audio signal so as to obtain better concordance with said tempo detected by said tempo detection means.

Advantageously, the terminal includes means for determining a new frequency from the frequency extracted from said note, said new frequency being equal to a theoretical frequency of a musical scale.

According to another highly advantageous embodiment, the terminal includes means for detecting the tonality of the music.

Advantageously, the terminal includes means for improving the frequencies of the notes associated with said received audio signal so as to obtain better concordance with the theoretical frequencies of the tonality detected by said tonality detection means.

Advantageously, the terminal includes means for manually modifying the frequency, the start time or the duration of a note.

Advantageously, said telecommunication terminal is a mobile telephone.

Further features and advantages of the present invention will become apparent in the following description of one embodiment of the invention, given by way of illustration but implying no limitation.

### BRIEF DESCRIPTION OF THE DRAWINGS

FIG. 1 shows schematically a telecommunication terminal according to the invention.

### DETAILED DESCRIPTION OF THE PREFERRED EMBODIMENTS

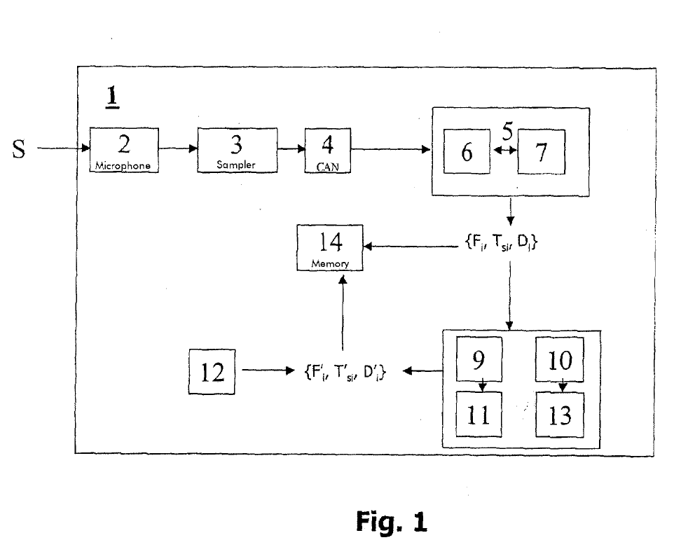

In FIG. 1, a telecommunication terminal 1 according to the invention comprises a microphone 2 for receiving an analog audio signal, a sampler 3 and an analog/digital converter 4, parameter extraction means 5, a tempo detector 9, means 11 for correcting the start times and the duration of notes, a tonality detector 10, means 13 for improving the frequencies of notes, means 12 for manually modifying notes, and a memory 14.

The means 5, 9, 10, 11 and 13 are software means executed by a programmable processor (not shown).

The extraction means 5 comprise a signal level detector 6 and frequency extraction means 7.

Using the terminal 1, such as a mobile telephone, the user transmits, for example by whistling, a sound signal S to the microphone 2.

This signal S is sampled by the sampler 3 and digitized by the analog/digital converter 4.

The extraction means 5 therefore receive a digital signal.

The signal level detector 6 allows the duration of the notes of the signal to be determined.

The frequency extraction means 7 employ a frequency detection method using, for example, an FFT (Fast Fourier Transform), a process of the zero-crossing type or a process based on the absolute mean difference function or the autocorrelation. The frequency extraction means 7 thus allow the frequencies associated with the digital signal to be determined.

The signal level detector 6 and the frequency extraction means 7 may also be combined: for this purpose, a criterion C₁ is calculated on the basis of the signal level detection, for example the instantaneous signal level value divided by the mean value over an elapsed time of 100 ms. A second criterion C₂ is calculated on the basis of the detection of the principal frequency of the signal such as, for example, the maximum value of the AMDF function divided by the mean value over the range of frequencies analyzed. These two criteria are combined into a decision criterion C_{d}=f(C₁, C₂) which is used to determine the start and the end of the notes. For example, the start of a note is detected when C_{d} exceeds a certain value C_{d0}.

The extraction means 5 therefore allow a set of frequencies to be determined, each frequency being associated with a duration, that will be represented without distinction hereafter by a set of three parameters {Fᵢ, Tᵢ, Dᵢ}, where Fᵢ is the frequency of the note i, Tᵢ is the start time of the note i and Dᵢ is the duration of the note i, or by a set of three parameters {Fᵢ, Tₛᵢ, Tₑᵢ}, where Fᵢ is the frequency of the note i, Tₑᵢ is the start time of the note i, i.e. Tᵢ and Tₛᵢ is the stop time of the note i. This therefore gives the duration Dᵢ, which is equal to the difference Tₑᵢ−Tₛᵢ.

It may then prove necessary to correct the duration and frequency values of the notes, these values not always corresponding either to theoretical note frequencies or to a theoretical tempo. This problem may arise from the insufficient quality of the microphone 2, from inaccuracy in the method used by the extraction means 5 or simply from a poor quality of sound whistled by the user.

The tempo detector 9 will start by detecting a tempo and then the means 11 will correct the start times and the duration of the notes associated with the received audio signal S so as to obtain better concordance with the detected tempo. To do this, the means 11 will, for example, determine new parameters T′ₛᵢ and D′ᵢ that are in concordance with this detected tempo.

Thus, the tempo detector 9 starts by determining a tempo suited to the input audio signal.

A method of determining such a tempo or beat consists, for example, in:

placing all of the Tₛᵢ values on a time scale starting from a time t=0;

defining a variable tempo B, for example between 0.5 and 4 beats per second (i.e. a black note duration of between 0.25 and 2 s); and

making B vary so that the variable tempo and the Tₛᵢ values are in concordance, for example by having a maximum Tₛᵢ value within an interval

$$[ k \times B - \frac{B}{10} ; k \times B + \frac{B}{10} ] ,$$

that is to say Tₛᵢ is within an interval smaller than a quarter of a beat, here a fifth, around the beat B.

The tempo detector 9 thus determines a value of B which will allow the correction means 11 to define new Tₛᵢ values, denoted T′ₛᵢ such that:

$${T}_{si}^{′} = k \times B + \frac{i \times B}{n} , where k ∈ N , i ∈ \{ 0 , 1 \} and n ∈ \{ 2 , 3 , 4 , \frac{4}{3} , \frac{8}{3} \} .$$

The tempo detector 9 and the correction means 11 operate likewise to determine parameters T′ₑᵢ, deduced from the parameters Tₑᵢ, and to deduce therefrom the value of D′ᵢ equal to T′ₑᵢ−T′ₛᵢ.

The means 13 for improving the note frequencies will improve the frequencies associated with said received audio signal so as to obtain better concordance with the theoretical frequencies of a musical scale so as to obtain new frequencies F′ᵢ corresponding to the theoretical notes of this scale.

One method of improving the tonality consists, for example, in assuming that the scale is a tempered diatonic scale and in adjusting the frequencies Fᵢ to the frequencies of the theoretical notes that are closest.

This method may be improved by precise detection of the tonality. To do this, the tonality detector 10 analyzes the frequencies Fᵢ to check whether they lie within intervals having a width equal to approximately three comas about a frequency of a diatonic note, such as F, F#, C or C#. By counting a significant number of frequencies within an interval, the detector deduces the tonality therefrom.

For example, if 15 F#s are found among 19 notes within the group of Fs and F#s and if 30 C#s are found among 32 notes within the group of Cs and C#s, there is a high probability that the tonality is D major.

The means 13 for improving the note frequencies will then round all the frequencies Fᵢ to the note frequencies of this tonality and determine the new frequencies F′ᵢ. The detected tonality is taken into account by defining larger decision intervals about the principal notes of the tonality.

The set of information consisting of the set of parameters {Fᵢ, Tₛᵢ, Dᵢ} or the improved set {F′ᵢ, T′ₛᵢ, D′ᵢ} is stored in a memory 14.

Finally, the user may modify the notes manually by using means 12 that incorporate, for example, a display device indicating the stave corresponding to the notes detected.

There is claimed:

1. A telecommunication terminal for generating a customized melody comprising input means for receiving an analog audio signal, that includes at least one note, means for sampling and converting said analog audio signal into a digital signal and means for extracting from said digital signal at least three parameters representative of said analog audio signal, these being the frequency, the start time and the duration of said note, which terminal includes means for modifying at least one of the three parameters so as to correct the sound imperfections associated with the quality or with the processing of said analog audio signal.

2. The telecommunication terminal claimed in claim 1, which includes tempo detection means.

3. The telecommunication terminal claimed in claim 2, said analog audio signal comprising a plurality of notes, wherein said terminal includes means for correcting the start times and the duration of the notes associated with said received audio signal so as to obtain better concordance with said tempo detected by said tempo detection means.

4. The telecommunication terminal claimed in claim 2, which includes means for determining a new frequency from the frequency extracted from said note, said new frequency being equal to a theoretical frequency of a musical scale.

5. The telecommunication terminal claimed in claim 3, which includes means for determining a new frequency from the frequency extracted from said note, said new frequency being equal to a theoretical frequency of a musical scale.

6. The telecommunication terminal claimed in claim 2, which includes tonality detection means.

7. The telecommunication terminal claimed in claim 3, which includes tonality detection means.

8. The telecommunication terminal claimed in claim 4, which includes tonality detection means.

9. The telecommunication terminal claimed in claim 7, said analog audio signal comprising a plurality of notes, which terminal includes means for improving the frequencies of the notes associated with said received audio signal so as to obtain better concordance with the theoretical frequencies of the tonality detected by said tonality detection means.

10. The telecommunication terminal claimed in claim 8, said analog audio signal comprising a plurality of notes, which terminal includes means for improving the frequencies of the notes associated with said received audio signal so as to obtain better concordance with the theoretical frequencies of the tonality detected by said tonality detection means.

11. The telecommunication terminal claimed in claim 9, which includes means for manually modifying the frequency, the start time or the duration of notes.

12. The telecommunication terminal claimed in claim 10, which includes means for manually modifying the frequency, the start time or the duration of notes.

13. The telecommunication terminal claimed in claim 1, which is a mobile telephone.

14. The telecommunication terminal claimed in claim 2, which is a mobile telephone.

15. The telecommunication terminal claimed in claim 3, which is a mobile telephone.

16. The telecommunication terminal claimed in claim 6, which is a mobile telephone.

17. The telecommunication terminal claimed in claim 8, which is a mobile telephone.

18. The telecommunication terminal claimed in claim 11, which is a mobile telephone.

19. The telecommunication terminal claimed in claim 12, which is a mobile telephone.
